(19) United States
(12) Patent Application Publication
(10) Pub. No.: US 2014/0119050 A1
(43) Pub. Date: May 1, 2014

(54) LIGHT-DIFFUSING PLATE, METHOD OF FABRICATING THE SAME AND LED ILLUMINATION DEVICE INCLUDING THE SAME

(71) Applicant: Samsung Corning Precision Materials Co., Ltd., Gyeongsangbuk-do (KR)

(72) Inventors: Kiyeon Lee, ChungCheongNam-Do (KR); Jhee-Mann Kim, ChungCheongNam-Do (KR); Jaeho Lee, ChungCheongNam-Do (KR)

(73) Assignee: Samsung Corning Precision Materials Co., Ltd., Gyeongsangbuk-do (KR)

(21) Appl. No.: 14/063,445

(22) Filed: Oct. 25, 2013

(30) Foreign Application Priority Data
Oct. 29, 2012 (KR) 10-2012-0120075

(51) Int. Cl. F21V 8/00; C03B 20/00; G02B 5/02

(52) U.S. Cl. CPC G02B 6/0051; G02B 5/0236; G02B 6/0063; C03B 20/00
USPC 362/607; 359/599; 362/606; 65/33.1

(57) ABSTRACT

A light-diffusing plate, a method of fabricating the same and a light-emitting diode (LED) illumination device including the same. The light-diffusing plate allows incident light to pass through, with the incident light diffused and scattered by the light-diffusing plate. The light-diffusing plate is made of crystallized glass in which crystals that diffuse and scatter the incident light are formed.

### CROSS REFERENCE TO RELATED APPLICATION

The present application claims priority from Korean Patent Application Number 10-2012-0120075 filed on Oct. 29, 2012, the entire contents of which are incorporated herein for all purposes by this reference.

### BACKGROUND OF THE INVENTION

1. Field of the Invention

The present invention relates to a light-diffusing plate, a method of fabricating the same and a light-emitting diode (LED) illumination device including the same, and more particularly, to a light-diffusing plate which allows incident light to pass through, with the incident light diffused and scattered by the light-diffusing plate, a method of fabricating the same and an LED illumination apparatus including the same.

2. Description of Related Art

In general, incandescent lamps or fluorescent lamps are widely used for indoor or outdoor illumination lamps. Incandescent lamps or fluorescent lamps have the drawbacks of short longevity and high power consumption. In addition, iodine lamps using the halogen cycle, high-efficiency halide lamps, cathode discharge lamps and the like have been recently developed. Electroluminescent (EL) lamps are a surface light source having a crystalline light-emitting structure, and are becoming more popular as a next-generation light source. However, EL lamps have not entered the stage of practical use due to problems such as efficiency, a light source device and the like.

Accordingly, illumination devices using light-emitting diodes (LEDs) were developed and widely distributed. LEDs have the advantages of a simple structure, adaptability to mass production, resistance to vibration and long lifespan. In addition, LEDs have a fast response speed since they generate light at the moment that a voltage at a threshold value or higher is applied.

However, illumination devices using LEDs have the problems of increased power consumption and massive heat generation since each illumination device consists of a large number of LEDs. In addition, LED illumination devices include a light-diffusing plate that scatters and diffuses light emitted from an LED light source. However, there are problems in that the light-diffusing plate decreases luminance, and that the uniformity of luminance is decreased more in a larger illumination device. Furthermore, it is difficult to decrease the thickness of LED illumination devices due to their structural limitations.

Reference will now be given in more detail to the light-diffusing plate that is used in an LED illumination device.

In general, the light-diffusing plate is fabricated by extruding polystyrene (PS) or polycarbonate (PC). Voids or a diffusing agent having a different refractive index from the light-diffusing plate is distributed inside the light-diffusing plate. The voids or diffusing agent inside the light-diffusing plate refracts or reflects light that has entered the light-diffusing plate. In particular, when a sufficient amount of voids or diffusing agent is present inside the light-diffusing plate, light that has entered the light-diffusing plate scatters after being refracted and reflected sufficient times inside the light-diffusing plate. Consequently, when the light that has entered the light-diffusing plate exits the light-diffusing plate, the intensity of the light is uniformized and the divergence angle thereof is increased. However, part of the light that has entered the light-diffusing plate is absorbed by the voids or diffusing agent while being refracted and reflected by the voids and diffusing agent inside the light-diffusing plate. Consequently, light loss occurs while the light passes through the light-diffusing plate.

In addition, Japanese Laid-Open Patent Publication No. 2012-32441 discloses an invention of a diffusing plate that is fabricated by applying a paste prepared by mixing two kinds of powder having different refractive indices on a glass substrate. In this related art, however, a problem may occur since organic substances in the paste are not sufficiently decomposed. In addition, harmful substances may be produced during binder burn-out, which is problematic.

The information disclosed in the Background of the Invention section is provided only for better understanding of the background of the invention, and should not be taken as an acknowledgment or any form of suggestion that this information forms a prior art that would already be known to a person skilled in the art.

### BRIEF SUMMARY OF THE INVENTION

Various aspects of the present invention provide a method of fabricating the same and a light-emitting diode (LED) illumination device including the same, and more particularly, to a light-diffusing plate which has high luminance and high uniformity of luminance, a method of fabricating the same and an LED illumination apparatus including the same.

In an aspect of the present invention, provided is a light-diffusing plate that allows incident light to pass through, with the incident light diffused and scattered by the light-diffusing plate. The light-diffusing plate is made of crystallized glass in which crystals that diffuse and scatter the incident light are formed.

According to an embodiment of the present invention, the size (diameter) of crystals formed in the crystallized glass may range from 0.01 to 0.1 μm.

The surface roughness (RMS) of the light-diffusing plate may be 1 μm or less.

The visible light (380-780 nm) transmittance of the light-diffusing plate may be 50% or greater.

In another aspect of the present invention, provided is a method of fabricating a light-diffusing plate that allows incident light to pass through, with the incident light diffused and scattered by the light-diffusing plate. The method includes the steps of: preparing a glass having a transmittance of 85% or greater, the glass being capable of being crystallized by heat treatment; and heat-treating the glass by heating to a temperature ranging from 900 to 1000° C., thereby crystallizing the glass.

In a further aspect of the present invention, provided is a light-emitting diode illumination device that includes a lightguide plate for guiding light; a light-emitting diode light source disposed at a side of the lightguide plate to emit light toward the lightguide plate; and a light-diffusing plate disposed on one surface of the lightguide plate through which the light is radiated outward, the light-diffusing plate diffusing and scattering the light. The light-diffusing plate is made of crystallized glass in which crystals that diffuse and scatter the light that has entered from the lightguide plate are formed.

According to an embodiment of the present invention, the lightguide plate may radiate the light through both surfaces, and the light-diffusing plate may include light-diffusing plates disposed on the both surfaces of the lightguide plate.

The size of the crystals formed in the crystallized glass may range from 0.01 to 0.1 μm.

The surface roughness of the light-diffusing plate may be 1 μm or less.

According to embodiments of the present invention, since the light-diffusing plate is made of crystalline glass, the light-diffusing plate can increase the luminance and uniformity of luminance of light that is discharged therefrom, and has high transmittance.

In addition, it is possible to decrease the thickness of an LED illumination device and emit light from one or both surfaces.

The methods and apparatuses of the present invention have other features and advantages which will be apparent from, or are set forth in greater detail in the accompanying drawings, which are incorporated herein, and in the following Detailed Description of the present invention, which together serve to explain certain principles of the present invention.

### BRIEF DESCRIPTION OF THE DRAWINGS

FIG. 1 is a schematic flow diagram showing a method of fabricating a light-diffusing plate according to an embodiment of the present invention;

FIG. 2 is a graph showing luminance measurements depending on the viewing angle before and after crystallization of a lightguide plate, a piece of common glass and a piece of crystallized glass;

FIG. 3 is a picture comparing the luminance measurements of pieces of crystallized glass depending on the heating temperature; and

FIG. 4 is a conceptual cross-sectional view showing an LED illumination device according to an embodiment of the present invention.

### DETAILED DESCRIPTION OF THE INVENTION

Reference will now be made in detail to a light-diffusing plate, a method of fabricating the same and a light-emitting diode (LED) illumination device including the same according to the present invention, embodiments of which are illustrated in the accompanying drawings and described below, so that a person having ordinary skill in the art to which the present invention relates can easily put the present invention into practice.

Throughout this document, reference should be made to the drawings, in which the same reference numerals and signs are used throughout the different drawings to designate the same or similar components. In the following description of the present invention, detailed descriptions of known functions and components incorporated herein will be omitted when they may make the subject matter of the present invention unclear.

The light-diffusing plate according to an embodiment of the present invention allows light emitted from a light source to pass through, with the light diffused and scattered by the light-diffusing plate, and can be made of crystallized glass in which crystals capable of diffusing and scattering the incident light are formed.

The crystallized glass refers to glass in which the array of molecules that constitute the glass are poly-crystallized due to reheating.

These crystals diffuse and scatter light that has entered the light-diffusing plate so that the light that exits the light-diffusing plate at a large divergence angle and with uniform intensity.

Since the light-diffusing plate according to the present invention is made of crystalline glass, the light-diffusing plate can increase the luminance and the uniformity of luminance of the light that exits the light-diffusing plate. In addition, since the light-diffusing plate according to the present invention is made of glass, it is highly transmissive. It is preferred that the transmittance of the light-diffusing plate according to the present invention be 50% or greater.

It is preferred that the size of crystals formed in the crystallized glass range from 0.01 to 0.1 μm. When the size of crystals exceeds 0.1 μm, light emitted from the light source may not efficiently pass through the crystals. In contrast, when the size of crystals is smaller than 0.01 μm, light emitted from the light source may not be efficiently scattered.

In addition, according to the present invention, it is preferred that the surface roughness of the light-diffusing plate be 1 μm or less.

When the light-diffusing plate is used for a light-emitting diode (LED) illumination device or the like, it is attached to a lightguide plate. In this case, it is preferred that an air gap is not situated between the light-diffusing plate and the lightguide plate.

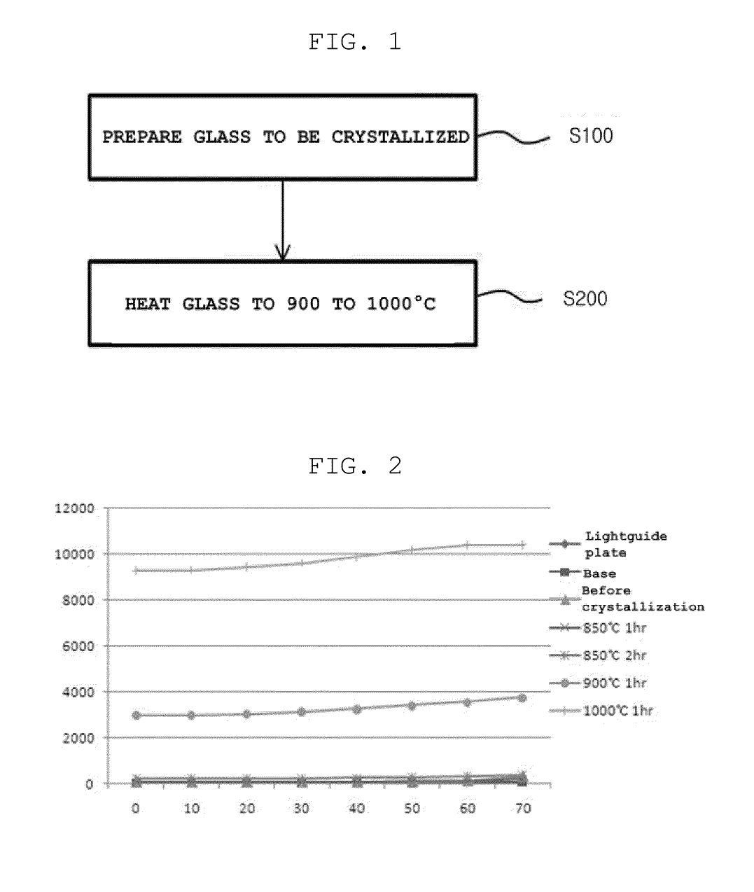

FIG. 1 is a schematic flow diagram showing the method of fabricating a light-diffusing plate according to an embodiment of the present invention.

Referring to FIG. 1, the method of fabricating a light-diffusing plate according to an embodiment of the present invention includes the step 5100 of preparing a piece of glass that has a transmittance of 85% or greater and crystallizes when heat-treated and the step 5200 of crystallizing the piece of glass by heat treatment by heating the piece of glass at a temperature ranging from 900 to 1000° C.

In order to fabricate the light-diffusing plate which allows light emitted from a light source or the like to pass through, with the light diffused and scattered by the light-diffusing plate, crystallized glass having a transmittance of 85% or greater and is by heat treatment is prepared. It is preferable that the transmittance of the glass before heat treatment be greater since the transmittance of the glass decreases when the glass is crystallized due to heat treatment.

Afterwards, the glass is crystallized by heat treatment by heating the glass to a temperature ranging from 900 to 1000° C.

Table 1 presents luminance measurements depending on the viewing angle before and after crystallization of a lightguide plate, a piece of common glass and a piece of crystallized glass, and FIG. 2 is a graph showing the same.

TABLE 1

| | | | Crystallized glass | | | | |
|---|---|---|---|---|---|---|---|
| | | Common | | 850° C./ | 850° C./ | 900° C./ | 1000° C./ |
| VA¹⁾ | LGP²⁾ | glass | BC³⁾ | 1 hr | 2 hr | 1 hr | 1 hr |
| 0 | 19 | 28 | 73 | 81 | 230 | 3001 | 9286 |
| 10 | 19 | 28 | 74 | 82 | 232 | 3012 | 9311 |
| 20 | 19 | 31 | 75 | 83 | 237 | 3064 | 9430 |
| 30 | 22 | 34 | 79 | 86 | 247 | 3153 | 9609 |
| 40 | 27 | 37 | 87 | 93 | 259 | 3270 | 9873 |
| 50 | 33 | 44 | 101 | 106 | 279 | 3411 | 10170 |
| 60 | 49 | 59 | 125 | 131 | 311 | 3571 | 10390 |
| 70 | 78 | 91 | 314 | 214 | 383 | 3768 | 10390 |

Note)
VA¹⁾: viewing angle,
LGP²⁾: lightguide plate,
BC³⁾: before crystallization

As apparent from Table 1 and FIG. 2, it can be understood that the luminance of the lightguide plate and the luminance of the common glass are much lower than that of the crystallized glass. It can also be understood that the luminance of the glass that was not subjected to heat treatment by heating and the luminance of the crystallized glass that was heated to a temperature of 850° C. or lower are lower than that of the crystallized glass according to the present invention.

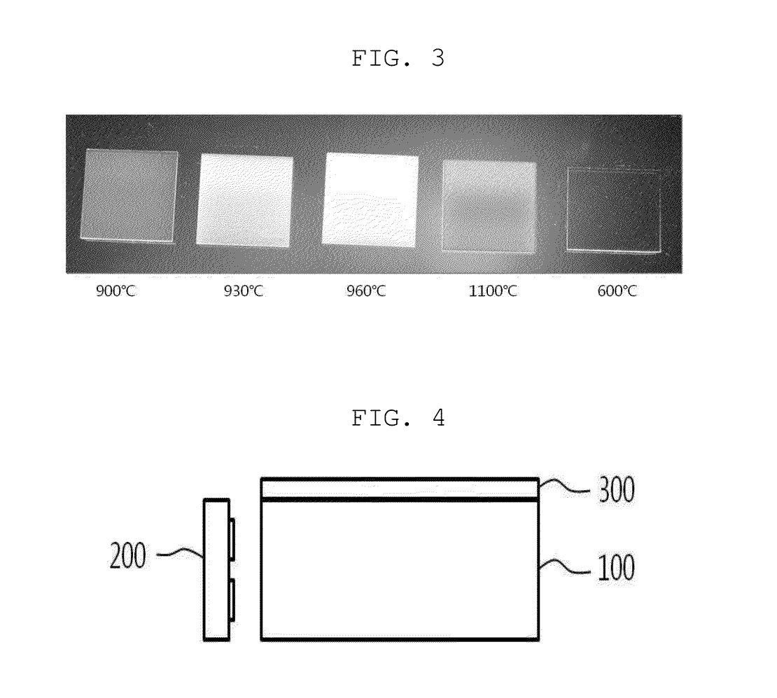

FIG. 3 is a picture comparing the luminance measurements of pieces of crystallized glass depending on the heating temperature.

As shown in FIG. 3, when the crystallized glass is heat-treated at a temperature of 600° C., the crystallized glass can discharge almost no light. When the crystallized glass is heat-treated at a temperature of 1100° C., the luminance of light discharged therefrom is very low. In FIG. 3, the black background indicates a lightguide plate.

FIG. 4 is a conceptual cross-sectional view showing an LED illumination device according to an embodiment of the present invention.

Referring to FIG. 4, the LED illumination device according to an embodiment of the present invention includes a lightguide plate 100, an LED light source 200 and a light-diffusing plate 300.

The lightguide plate 100 guides light that has been emitted from the LED light source 200 which is disposed adjacent to one side of the lightguide plate 100 to the light-diffusing plate 300.

It is preferred that the lightguide plate 10 be made of a polymeric material that has a lower refractive index than the outside air gap and is optically transparent, such as acrylate monomer or poly (methyl methacrylate) (PMMA), an acrylic polymer. Since the refractive index of the lightguide plate 10 is lower than that of the outside air gap, the light that has entered the lightguide plate 10 through the side surface from the LED light source 200 is distributed inside the lightguide plate 100 while traveling in the horizontal direction since it is totally internally reflected without exiting the lightguide plate 100.

Since the LED illumination device according to an embodiment of the present invention is a side emission type instead of being a top emission type, the number of LEDs per unit area used in the LED illumination device of the present invention can be reduced than that used the related-art LED illumination device in which LEDs are disposed over the entire area of the lightguide plate. It is therefore possible to minimize power consumption required for operating the LED light source and resultant heat generation, reduce fabrication cost, and reduce the thickness.

A reflective pattern can be formed on one surface of the light-diffusing plate 100 that is opposite to the surface through which light exits (light emitting surface), i.e. the surface on which the light-diffusing plate 30 is disposed. The reflective pattern reflects light that has entered from the LED light source 200 toward the light emitting surface. That is, it is possible to make the light that has entered from the LED light source 200 exit only through the light emitting surface and one side surface without exiting in the direction opposite to the light emitting surface, thereby preventing the light from being lost.

The LED light source 200 is the light source which is disposed at the side of the lightguide plate 100 and emits light toward the lightguide plate 100. It is preferred that the LED light source 200 include a plurality of LEDs that are arranged in the form of an array.

The light-diffusing plate 300 is implemented as a piece of crystallized glass which is disposed on one surface of the lightguide plate 100 through which light exits, and allows incident light to exit, with the incident light diffused and scattered by the light-diffusing plate, and in which crystals are formed.

The light-diffusing plate 300 allows light that has entered from the lightguide plate 100 to exit, with the light diffused and scattered by the light-diffusing plate so that uniform intensity light can exit at a large divergence angle.

Since the light-diffusing plate 300 is made of crystallized glass, it is possible to increase the luminance and the luminance uniformity of light that exits through the LED illumination device.

As described above, it is preferred that the size of crystals formed in the crystallized glass range from 0.01 to 0.1 μm.

In addition, it is preferred that the surface roughness of the light-diffusing plate 300 be 1 μm or less in order to prevent an air gap from being situated between the lightguide plate 100 and the light-diffusing plate 300 disposed on one surface of the lightguide plate 100.

In addition, in the LED illumination device according to an embodiment of the present invention, the lightguide plate 100 can be configured such that it radiates light through both surfaces, and light-diffusing plates 300 can be disposed on both surfaces of the lightguide plate 100 through which light exits.

With this structure, the LED illumination device of the present invention can radiate light through both surfaces. In this case, the lightguide plate 100 can be implemented as a lightguide plate without a reflective pattern since it is not required to radiate light that has entered from the LED light source through only one surface.

The foregoing descriptions of specific exemplary embodiments of the present invention have been presented with respect to the drawings. They are not intended to be exhaustive or to limit the present invention to the precise forms disclosed, and obviously many modifications and variations are possible for a person having ordinary skill in the art in light of the above teachings.

It is intended therefore that the scope of the present invention not be limited to the foregoing embodiments, but be defined by the Claims appended hereto and their equivalents.

What is claimed is:

1. A light-diffusing plate that allows incident light to pass through, with the incident light diffused and scattered by the light-diffusing plate, comprising crystallized glass in which crystals that diffuse and scatter the incident light are formed.

2. The light-diffusing plate of claim 1, wherein a size of the crystals formed in the crystallized glass ranges from 0.01 to 0.1 μm.

3. The light-diffusing plate of claim 1, wherein a surface roughness (RMS) of the light-diffusing plate is 1 μm or less.

4. The light-diffusing plate of claim 1, wherein a visible light transmittance of the light-diffusing plate is 50% or greater.

5. A method of fabricating a light-diffusing plate that allows incident light to pass through, with the incident light diffused and scattered by the light-diffusing plate, the method comprising:
preparing a glass having a transmittance of 85% or greater, the glass being capable of being crystallized by heat treatment; and
heat-treating the glass by heating to a temperature ranging from 900 to 1000° C., thereby crystallizing the glass.

6. A light-emitting diode illumination device comprising:
a lightguide plate for guiding light;
a light-emitting diode light source disposed at a side of the lightguide plate to emit light toward the lightguide plate; and
a light-diffusing plate disposed on one surface of the lightguide plate through which the light is radiated outward, the light-diffusing plate diffusing and scattering the light,
wherein the light-diffusing plate comprises crystallized glass in which crystals that diffuse and scatter the light that has entered from the lightguide plate are formed.

7. The light-emitting diode illumination device of claim 6, wherein the lightguide plate radiates the light through both surfaces thereof, and the light-diffusing plate comprises light-diffusing plates disposed on the both surfaces.

8. The light-emitting diode illumination device of claim 6, wherein a size of the crystals formed in the crystallized glass ranges from 0.01 to 0.1 μm.

9. The light-emitting diode illumination device of claim 6, wherein a surface roughness of the light-diffusing plate is fpm or less.
